(19) United States
(12) Patent Application Publication
(10) Pub. No.: US 2016/0307242 A1
(43) Pub. Date: Oct. 20, 2016

(54) METHODS FOR FACILITATING A LOCATION TOUR WITH LOCATION RATING AND DEVICES THEREOF

(71) Applicant: Todd Alan Kuhlmann, Austin, TX (US)

(72) Inventor: Todd Alan Kuhlmann, Austin, TX (US)

(21) Appl. No.: 14/690,013

(22) Filed: Apr. 17, 2015

(51) Int. Cl. G06Q 30/02; G06Q 50/16

(52) U.S. Cl. CPC G06Q 30/0278; G06Q 50/16

(57) ABSTRACT

Disclosed are methods and devices for facilitating a location inspection and property tour. A location inspection computing device may receive at least one first rating of one or more characteristics associated with one or more locations, properties, units, parcels or sections. The first rating may be based on perceived importance of the one or more characteristics to a user. The method further comprises receiving, by the location inspection computing device, additional locations, properties, units, parcels or sections included in the location inspection tour and at least one second rating of the one or more characteristics being provided by the user while inspecting each location, property, unit, parcel or section. Further a composite rating for the listing of each location, property, unit, parcel or section is computed based on the at least one first rating and the at least one second rating.

### TECHNICAL FIELD

The present subject matter described herein, in general, relates to real estate sector, and more particularly to methods and devices for facilitating a location tour with location rating.

### BACKGROUND

Owning and renting a house or property is a basic human need. In order to fulfill this basic human need, various options are available. Some of these options include buying, selling or leasing house directly or through an agent. Latest addition to these options are online property portals that include a wide variety of listings of properties that caters to different strata of society. Most of the online property portals do not provide a comparative report between different properties that can help a user to make a judicious decision as to buying, selling or renting the property.

Online property portals typically rank the properties on the basis of one or more characteristics associated with the property. The one or more characteristics include location, size, price, amenities etc. However, the drawbacks associated with this ranking approach is that user perception and user importance regarding the one or more characteristics associated with the property is not taken into consideration both at the time of listing of the properties and at the time of the location inspection tour. The online property portals come with their own method to rank the properties based on the one or more characteristics.

In view of the above drawbacks, there is need to have methods and devices to facilitate the identification of the appropriate property. Further, while ranking the properties, it would be desirable to take into consideration user rating of the properties both at the time of the listing of the properties and during the actual location tour.

### SUMMARY

This summary is provided to introduce concepts related to methods and devices for facilitating a location tour with location rating and the concepts are further described below in the detailed description. This summary is not intended to identify essential features of the claimed subject matter nor is it intended for use in determining or limiting the scope of the claimed subject matter.

Disclosed herein is a method for facilitating a location inspection. The method may receiving, using a location inspection computing device, a listing of one or more locations, properties, units, parcels or sections to be inspected; receiving, by the location inspection computing device, at least one first rating of one or more characteristics associated with the one or more locations, properties, units, parcels or sections, the rating being based on perceived importance of the one or more characteristics as assigned by and entered by a user; receiving, by the location inspection computing device, additional locations, properties, units, parcels or sections included in the location inspection tour and at least one second rating of the one or more characteristic being provided by the user while inspecting each location, property, unit, parcel or section; and computing, by the location inspection computing device, a composite rating for the listing of each location, property, unit, parcel or section based on the first rating and the second rating.

In an aspect of the present disclosure, a location inspection computing device for facilitating a location inspection tour is disclosed. The location inspection computing device may include one or more hardware processors and a memory storing instructions that, when executed by the one or more hardware processors, cause the one or more hardware processors to perform operations. The operations may include receiving, by a location inspection computing device receiving, using a location inspection computing device, a listing of one or more locations, properties, units, parcels or sections to be inspected; receiving, by the location inspection computing device, at least one first rating of one or more characteristics associated with the one or more locations, properties, units, parcels or sections, the first rating being based on perceived importance of the one or more characteristics as assigned by and entered by a user; receiving, by the location inspection computing device, additional locations, properties, units, parcels or sections included in the location inspection tour and a second rating of the one or more characteristic being provided by the user while inspecting each location, property, unit, parcel or section; and computing, by the location inspection computing device, a composite rating for the listing of each location, property, unit, parcel or section based on the first rating and the second rating.

In another aspect of the present disclosure, a non-transitory computer readable medium storing instructions for facilitating a location inspection that, when executed by one or more hardware processors, cause the one or more hardware processors to perform operations is disclosed. The operations may include receiving, using a location inspection computing device, a listing of one or more locations, properties, units, parcels or sections to be inspected; receiving, by the location inspection computing device, at least one first rating of one or more characteristics associated with the one or more locations, properties, units, parcels or sections, the first rating being based on perceived importance of the one or more characteristics as assigned by and entered by a user; receiving, by the location inspection computing device, additional locations, properties, units, parcels or sections included in the location inspection tour and a second rating of the one or more characteristic being provided by the user while inspecting each location, property, unit, parcel or section; and computing, by the location inspection computing device, a composite rating for the listing of each location, property unit, parcel or section based on the first rating and the second rating.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the leftmost digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment for facilitating a location inspection with location rating in accordance with some embodiments of the present disclosure.

FIGS. 2A-2F illustrates the method of facilitating the inspection of the locations, properties, units, parcels, or selections in accordance with some embodiments of the present disclosure.

FIG. 3 is a flowchart of a method of facilitating inspection of one or more locations, properties, units, parcels or sections in accordance with some embodiments of the present disclosure; and

FIG. 4 is a flowchart of a method of facilitating inspection of one or more locations, properties, units, parcels or sections in accordance with some embodiments of the present disclosure.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . , a” does not, without more constraints, preclude the existence of other elements or additional elements in the system or apparatus.

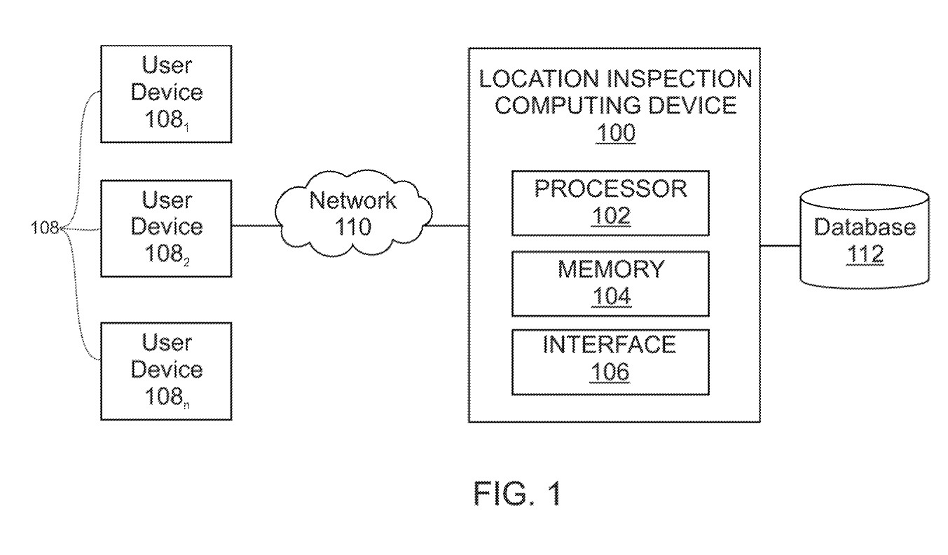

Embodiments of the present disclosure are directed to methods and devices for facilitating a location inspection with location rating. A location inspection computing device may receive one or more ratings of one or more characteristics associated with one or more locations, properties, units, parcels or sections. The ratings may be based on perceived importance of the one or more characteristics to a user. Further a listing of one or more locations, properties, units, parcels or sections to be inspected may be received based on one or more inputs from the user and the received ratings. Another rating to the listing of one or more locations, properties, units, parcels or sections may be assigned based on the one or more characteristics. The rating may be assigned by the user while inspecting the listing of one or more locations, properties, units, parcels or sections. Further, the location inspection computing device computes a composite rating for the listing of each location, property, unit, parcel or section based on the ratings based on the perceived importance and the ratings assigned by the user. FIG. 1 illustrates an exemplary environment for facilitating a location inspection in accordance with some embodiments of the present disclosure.

As shown in FIG. 1, the environment comprises a location inspection computing device 100 for facilitating the inspection of one or more locations, properties, units, parcels or sections. The environment also comprises one or more user devices 108₁, 108₂, . . . 108ₙ (collectively referred to as user devices 108) and a database 112 connected to the location inspection computing device 100. As shown in the FIG. 1, the user devices 108 are communicatively coupled to location inspection computing device 100 through a network 110 for receiving input data. The database 112 may comprise data regarding the one or more locations, properties, units, parcels or sections. In one exemplary embodiment, the database 112 may further be communicatively coupled to a remote database. The remote database may comprise data regarding the one or more locations, properties, units, parcels or sections. The remote database may be a read only database. The database 112 may fetch the data regarding the one or more locations, properties, units, parcels or sections from the remote database on receiving an input from one of the user devices 118 through the location inspection computing device 100.

The user devices 108 comprise an application program that uses the services of the location inspection computing device 100. The user devices 108 with the application program may be implemented in a variety of computing systems, such as a laptop computer, a desktop computer, a notebook, a workstation, a mainframe computer, a server, a network server, and mobile devices such as smart phones, tablets, PDA's, and the like. The user devices 108 may be used by various users who are interested in buying, selling and leasing the one or more locations, properties, units, parcels or sections.

In an embodiment, the user devices 108 are used by associated users to receive input data regarding the one or more locations, properties, units, parcels or sections and other information relating to the location inspection tour with location rating. The user devices 108 are installed with interface 106 for communicating with the location inspection computing device 100 over the network 110. It will be understood by one skilled in the art that connections to the network 110 may be wired, wireless or any combination thereof. For example, the user devices 108 maybe connected to the location inspection computing device 100 through wireless local area network (WLAN) technologies (e.g., Wi-Fi, 3G, Long Term Evolution (LTE)) or through a physical network connection to a computer network router or switch (e.g., Ethernet).

In one implementation, the location inspection computing device 100, as shown in FIG. 1, includes a central processing unit (“CPU” or “processor”) 102, a memory 104 and an interface 106. The processor 102 may comprise at least one data processor for executing program components and for executing user- or system-generated requests. A user may include a person, a person using a device such as those included in this invention, or such, a device itself. The processor 102 is configured to fetch and execute computer-readable instructions stored in the memory 104. The processor 102 may include specialized processing units such as integrated system (bus) controllers, memory management control units, floating point units, graphics processing units, digital signal processing units, etc. The processor 102 may use operating system stored in the memory 104. The operating system includes, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

In one implementation, the memory 104 is communicatively coupled to the processor 102. The memory 104 stores processor-executable instructions to facilitate location inspection. The location may comprise data regarding the one or more locations, properties, units, parcels or sections. In one example, the memory 104 may include, without limitation, RAM, ROM, etc. Additionally, in one implementation, the memory 104 is communicatively coupled to the processor 102 via a storage interface (not shown). The storage interface may connect to memory 104 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices solid-state drives, etc.

The location inspection computing device 100 may include the input/output (I/O) interface 106 for communicating with the one or more user devices 108. In an implementation, the location inspection computing device 100 also acts as user device. Therefore, the input data is directly received at the risk assessment computing device 100 for facilitating inspection of one or more locations, properties, units, parcels or sections. The database 112 stores data regarding the one or more locations, properties, units, parcels or sections.

The user enters, selects or uploads location, properties, units, parcels or selections to the database 112 via the user device 108. There are plurality of options like enter new property, edit existing property, lease tours, sale tours. Once the user selects a particular option, a screen may open allowing the user to select from a list of recent existing/saved property tours and folders that they have previously created. Also, on this screen, a sync icon may be added in the upper right corner allowing the user to do a manual sync and retrieve any property tours created/updated on another device. This will only work when device has Internet access. If no Internet access, a popup notice may be provided to sync when connected to the internet. In one embodiment, a new folder icon may be included to create a new folder. Add“+” Plus button to create a new tour.

The user may select, order to view, tour and/or inspect the selected locations, properties, units, and parcels. The locations, properties, units, parcels or selections may be geocoded on a map for user to view, save, print, and/or obtain directional instructions. There is also another option for the user to view location properties, units, parcels or selections in a list view to reorder, delete, view, save, print, and/or obtain directional instructions. Further, the user may be prompted to rank one or more characteristics associated with the locations, properties, units, parcels, or selections. The one or more characteristics may include price, size, location, layout, aesthetics, amenities, common area, security, and parking.

When viewing, inspecting and/or touring the location, the user will use a rating system to provide rating for the locations, properties, units, parcels, or selections between good and poor or high and low. For example, the following items may be rated: price, size, location, layout, aesthetics, amenities, common area, security, and parking. User may select from predetermined items or user can choose custom items to be rated.

The rating for the locations, properties, units, parcels, or selections may provide ability for the user to select the importance of each rating item, thereby allowing the user to customize the weight or reliance of the item in final comparison report. For example, user may select the property location is more important item to the user then the age of the property. In this case, the user can indicate higher importance on location and lower importance on age for final algorithm used to rate and compare the locations, properties, units, parcels, or selections.

The user may add additional information regarding the location, property, unit, parcel or selection before, after or during the inspection/tour. Additional information may include photographs, notes, floor plans, or other information specific for that location, property, unit, parcel or selection.

Upon completion of inspection/tour, the user may generate a report to provide details of each location, property, unit, parcel or selection that was inspected/toured. Upon completion of inspection/tour a comparison and rating report may be generated providing a comparison and/or rating for each location, property, unit, parcel or selection. In an exemplary embodiment, an algorithmic formula may used to show the user the rating and rank for the locations, properties, units, parcels, or selections. The report may be shown on computer and/or mobile device allowing user to interact with the report and adjust ratings. The Report may be generated and distributed in a format such as PDF or HTML document which can then be emailed, printed, and/or saved. For example, the rating of each of the locations, properties, units, parcels, or selections may be calculated as follows. Firstly, the user selects default rating categories or enters custom categories. The categories may be price, size, location, layout, aesthetics, amenities, security, and parking. User presets the rating importance from “Not Important” to “Very Important”. During tour or inspection, the user rates locations, properties, units, parcels, or selections for each of the categories.

The location inspection computing device 100 calculates the total rating based on:
a. Weighted rating based on selected importance of rating and rating given.
b. Price Example:
   i. User sets Price importance setting to 10—very important.
   During Tour, user rates Price as a 3 out of 5.
   iii. Algorithm computes Price rating at 30=10 times 3.
c. Location Example:
   i. User sets Location importance setting to 6—somewhat important.
   ii. During tour, User rates price as 4 out of 5.
   iii. Algorithm computes Location rate at 24=6 times 4.
d. Totals. The sum of all weighted ratings for all items for each location, property, unit, parcel or selection is presented with the highest sum being the highest rated location, property, unit, parcel or selection. In an embodiment, the location inspection computing device will order by top rated first and lowest rated last.

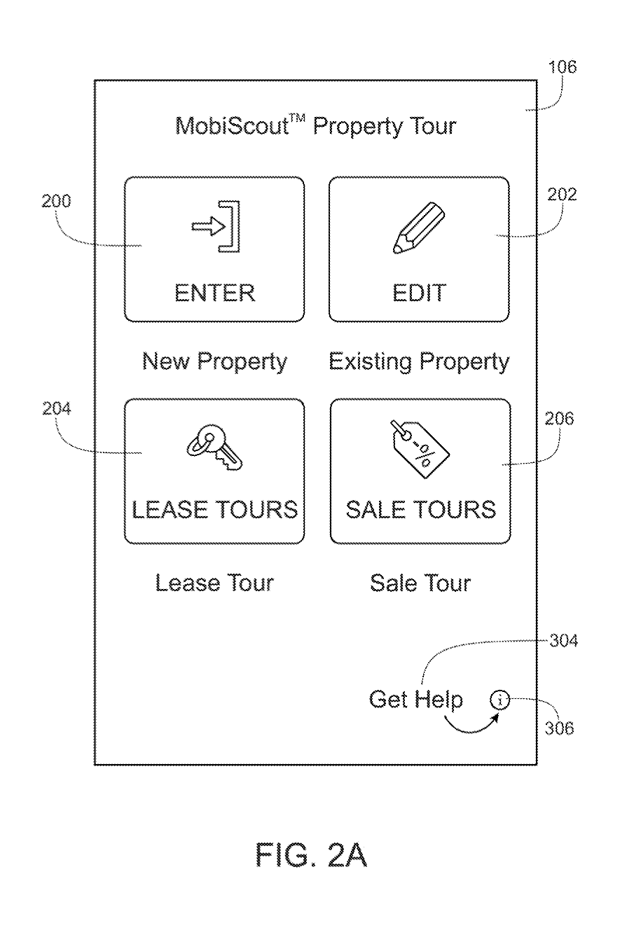

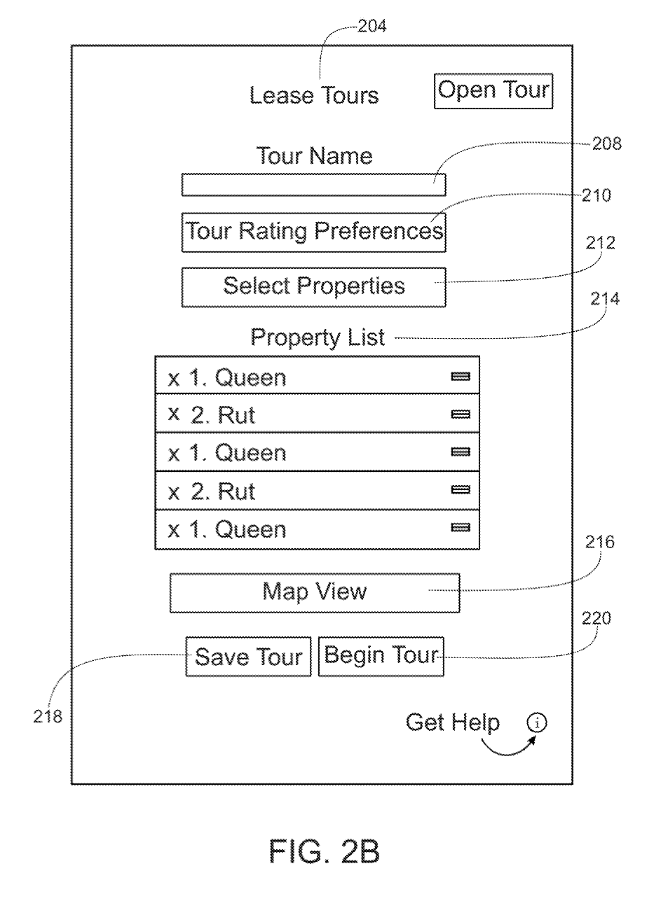

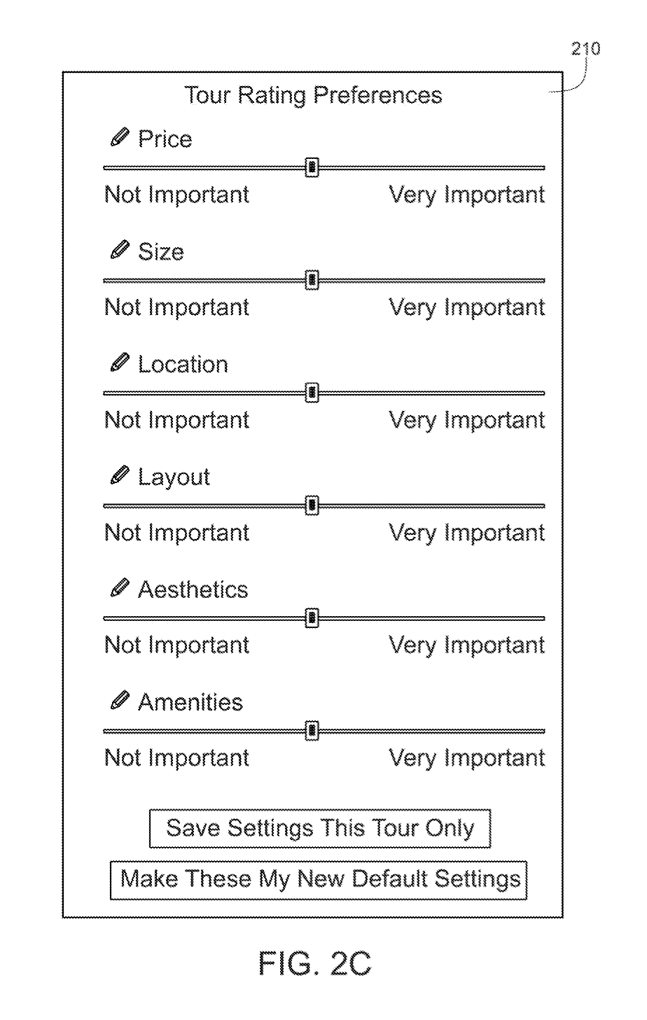

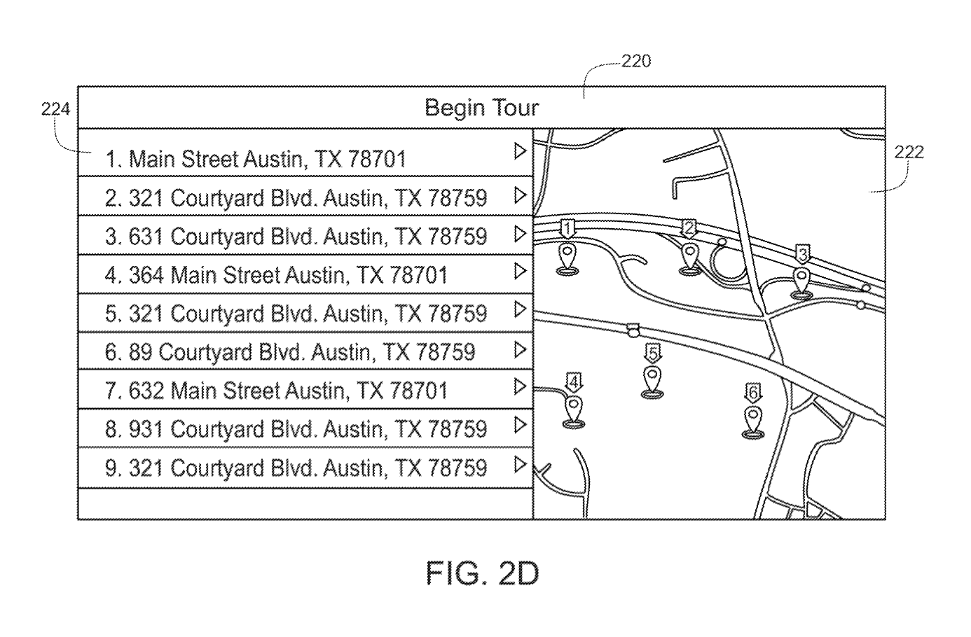

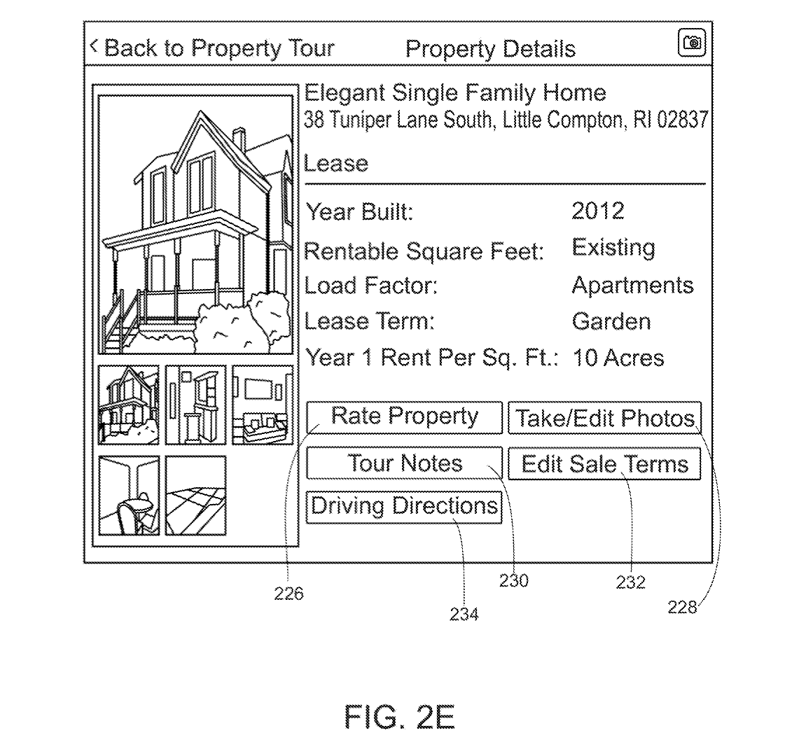

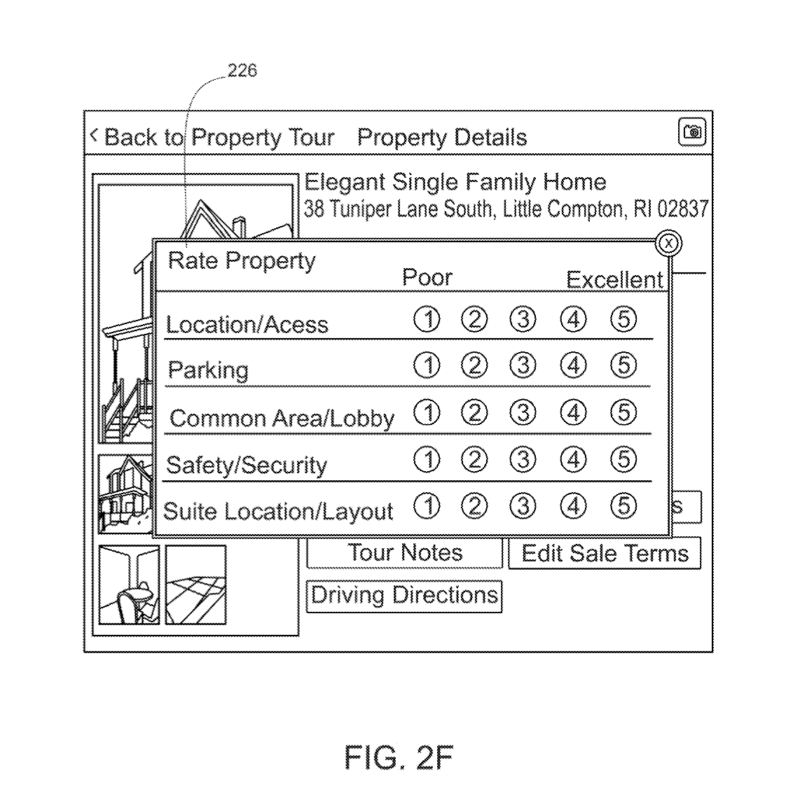

FIGS. 2A-2F illustrates the method of facilitating the inspection of the locations, properties, units, parcels, or selections in accordance with some embodiments of the present disclosure.

In FIG. 2A, there are plurality of options in the form of icons like enter new property 200, edit existing property 202, lease tours 204, sale tours 206. The icons 304 and 306 toggles.

In FIG. 2B, the icon lease tours 204 has been selected. In another embodiment, the sale tours may be selected. There are plurality of icons with different functionalities like tour name 208, tour rating preferences 210, select properties 212, property list 214, map view 216, save tour 218, and begin tour 220.

The property list 214 includes the listing of location, property, unit, parcel or selection from which user has to select the property for the tour. When the map view 216 is selected, locations, properties, units, parcels or selections are geocoded on a map. Save tour 218 saves the locations, properties, units, parcels or selections to be inspected by the user during the tour.

When the tour rating preferences 210 is selected, a new window opens (shown in FIG. 2C). One or more characteristics associated with the location, property, unit, parcel or selection are shown in FIG. 2C. The one or more characteristics may be price, size, location, layout, aesthetics, and amenities. User may also edit the rating names thereby customizing the rating characteristics. A side bar label is shown to select the tour rating preferences 210 from “not important” to “very important”. User selects the tour rating preferences 210 based on the perceived importance of the one or more characteristics to the user. There are two more options provided to save the tour rating preferences 210 for the current tour only or to save the tour rating preferences 210 as the default ratings.

As shown in FIG. 2D, when the begin tour 220 is selected, map view 222 and the list view 224 are shown. The map view 222 shows the properties in the form of a map showing their locations and the list view lists out the property. The properties are shown in the order in which they have to be toured. For example, first property to be toured is assigned numeral 1, second property to be toured is assigned numeral 2. If the order of the properties in the list view 224 changes, the order of the properties in the map view also changes.

When a particular property in the list view 224 and the map view 222 is clicked, a new window opens (shown in FIG. 2E). The new window illustrates the details of the property and there are other plurality of options like rate property 226, take/edit photos 228, tour notes 230, edit sale terms 232, and driving directions 234.

When the rate property 226 icon is selected, a new window opens (shown in FIG. 2F). There are one or more characteristics on which the user has to rate the property. In the exemplary embodiment, rating from 1 to 5 is considered for the one or more characteristics. Numeral 5 stands for excellent and 1 stands for poor. Finally, a combined rating is given to the property based on the tour rating preferences 210 and the above rating of the property. This has been explained in detail in conjunction with FIG. 1.

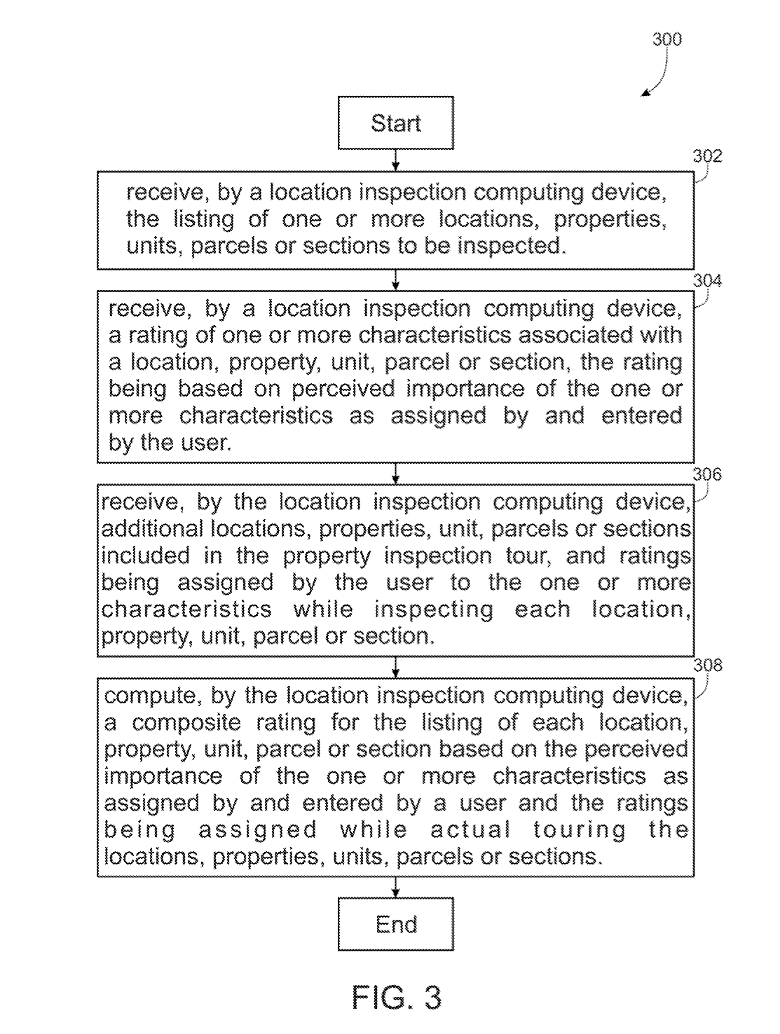

FIG. 3 is a flowchart 300 of a method of facilitating inspection of one or more locations, properties, units, parcels or sections in accordance some embodiments of the present disclosure.

At step 302, receive, by a location inspection computing device, the listing of one or more locations, properties, units, parcels or sections to be inspected

At step 304, receive, by a location inspection computing device, a rating of one or more characteristics associated with a location, property, unit, parcel or section, the rating being based on perceived importance of the one or more characteristics as assigned by and entered by a user.

At step 306, receive, by the location inspection computing device, additional locations, properties, units, parcels or sections included in the property inspection tour, and ratings being assigned by the user to the one or more characteristics while inspecting each location, property, unit, parcel or section.

At step 308, compute by the location inspection computing device, a composite rating for the listing of each location, property, unit, parcel or section based on the perceived importance of the one or more characteristics as assigned by and entered by a user and the ratings being assigned while actual touring the locations, properties, units, parcels or sections.

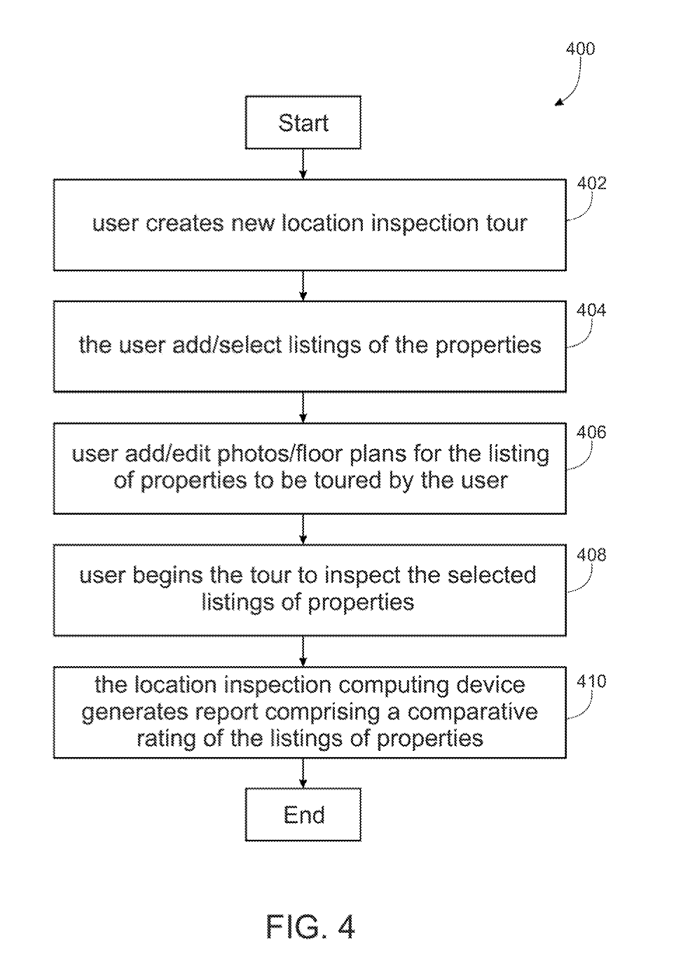

FIG. 4 is a flowchart 400 of a method of facilitating inspection with location rating of one or more locations, properties, units, parcels or sections in accordance with some embodiments of the present disclosure.

At step 402, user creates new location inspection tour. The user may select/create folder to save the tour.

Enter: “Tour Title/Client Name” text field. The tour will be saved under this name. Select “Lease” or “Purchase” tour (button that toggles between the two options). There may be “Overview & Objectives:” note field. The user asked to rate one or more characteristics associated with the property on a scale of 1-10, 10 highest importance. The one or more characteristics may be price, size, location, layout, aesthetics, amenities, common area, parking, and security. Slide bar labels can be changed to customize the tour/inspection for each user. “Next” button at bottom right of screen to take user to step 404.

At step 404, the user add/select listings. There are various options to add/select listings. In one exemplary embodiment, the user may select “Available Company Listing.” List view of listings is shown with ability for user to search by keyword—including property name/property address. In an exemplary embodiment, user may enter the Multiple Listing Service (MLS) number. Once property is selected, user must select listing in that property. If, in step 402, user selects lease, only show available for lease listings. If user selects Purchase, only show available for sale listings. Available listings/properties may be selected from the remote company property/listing database that already exists. The database 112 may be used for the tour property listings. As explained earlier, the user may not add/change listings in the remote database of active properties/listings that are available. If the user selects the listing from the remote database, that information will copy over to the database 112. If a user manually adds a listing to the tour, it will not write to the remote database, but only to the database 112.

In another exemplary embodiment, the user select “Previously Entered Listing” to search for listing previously entered and used in a property tour.

In yet another exemplary embodiment, there is option for the user to add listing. Once user selects listing or add listing, window appears for user to edit the listing or add information if new listing. One or more lease fields for user to enter/edit may be (Use these fields when user selects Lease at step 402): Listing Name, Address, Unit #, City, State, Zip Code, Year Built,

Listing Description:
Rentable space (number). Dropdown select type
   Sq. Feet (default)
   Sq. Meters
   Acres
Rental Rate (Dollar amount). Dropdown select type:
   SqFt/Year (default)
   SqFt/Month
   Sq. Meter/Year
   Sq. Meter/Month
   Acres/Year
   Acres/Month
   Amount/Year
   Amount/Month
Lease Type. Dropdown Selection
   Absolute Gross
   Modified Gross/Hybrid (default)
   Absolute Net
   Other
Expense Pass-through To Tenant (Dollar amount). Dropdown select type:
   SqFt/Year (Default)
   SqFt/Month
   Sq. Meter/Year
   Sq. Meter/Month
   Acres/Year
   Acres/Month
   Amount/Year
   Amount/Month
   Percentage Rent/Year
Lease Term (# of months) (36 is default)
Months Free Rent (number) (0 is default)
Concessions amount (Dollar Amount) ($0.00 is default)
Annual lease escalation (%.Default 3%)
   Similarly, there are sale fields for the user to enter/edit when the user has selected purchase in step 402.

At step 406, user may add/edit photos/floor plans for the listing of properties to be toured by the user. The user selects default photo by ordering it as the first image (Default photo will show first on reports). After adding/editing photo, the user is prompted with a plurality of options like add another Listing (Go back to step 404), Begin Tour (Go to Step 408), Create New Tour (Go to Step 402).

At step 408, user begins the tour to inspect the selected listing of properties. This has been explained in detail in conjunction with FIGS. 2A-2F.

At step 410, the location inspection computing device generates reports comprising a comparative rating of the listing of properties toured by the user.

The specification has described systems and methods for facilitating location tour of the user. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms a″ “an”, and “the” include plural references unless the context clearly dictates otherwise.

Furthermore, one or more compute readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

In the above disclosure, only a rating before the start of the tour and another rating after the start of the tour is disclosed. However, it will be appreciated to a person skilled in the art there is no limit on the number of methods for calculating rating. There can be one or more first ratings and one or more second ratings. It is pertinent to note that terms like the first and the second signifies there is one rating taken before the start of the tour and there is another rating taken during the course of the tour. It does not mean we can not have more than one first rating and more than one second rating. Further, It is intended that the disclosure and examples be considered as exemplary only.

We claim:

1. A method for facilitating a location inspection tour and property rating, the method comprising:
receiving, using a location inspection computing device, a listing of one or more locations, properties, units, parcels or sections to be inspected;
receiving, by the location inspection computing device, at least one first rating of one or more characteristics associated with the one or more locations, properties, units, parcels or sections, the first rating being based on perceived importance of the one or more characteristics as assigned by and entered by a user;
receiving, by the location inspection computing device, additional locations, properties, units, parcels or sections included in the location inspection tour and at least one second rating of the one or more characteristics being provided by the user while inspecting each location, property, unit, parcel or section; and
computing, by the location inspection computing device, a composite rating for the listing of each location, property, unit, parcel or section based on the at least one first rating and the at least one second rating.

2. The method as claimed in claim 1, wherein the composite rating is the weighted sum of the first rating and the second rating.

3. The method as claimed in claim 1, further comprising:
generating, by the location inspection computing device, a list view and a map view of the listing of one or more locations, properties, units, parcels or sections, wherein ordering of the listing of the one or more locations properties, units, parcels or sections in the list view correspond to numerals assigned to the one or more locations, properties, units, parcels or sections in the map view, and wherein numerals assigned to the one or more locations, properties, units, parcels or sections changes in response to change in the ordering of the listing of the one or more locations, properties, units, parcels or sections in the list view.

4. The method as claimed in claim 1, further comprising receiving notes and photographic images of the listing of one or more location, properties, unit, parcels or section from the user while inspecting the listing of one or more locations, properties, units, parcels or sections.

5. The method as claimed in claim 1, wherein the one or more characteristics associated with one or more location, properties, units, parcel or section comprise at least one of price, size, location, layout, aesthetics, amenities, common area, security, and parking.

6. The method as claimed in claim 1, wherein the one or locations, properties, units, parcels or sections comprise at least one of on sale locations, properties, units, parcels or sections or on lease locations, properties, units, parcels or sections.

7. The method as claimed in claim 1, wherein receiving, by the location inspection computing device, the listing of one or more locations, properties, units, parcels or sections based on one or more inputs from the user and the received rating comprises:
receiving the listing of one or more locations, properties, units, parcels or sections from a locally residing database, wherein the locally residing database comprises the listing of one or more locations, properties, units, parcels or sections fetched from a communicatively coupled remote database, the remote database being a read only database.

8. The method as claimed in claim 7, wherein receiving, by the location inspection computing device, the listing of one or more locations, properties, units, parcels or sections based on one or more inputs from the user and the received rating comprises:
receiving a listing of one or more locations, properties, units, parcels or sections manually entered by the user in the locally residing database.

9. The method as claimed in claim 1, further comprising generating a ratings report related to inspection of the listing of locations, properties, units, parcels or sections.

10. A location inspection computing device for facilitating a location inspection tour, the location inspection computing device comprising:
one or more hardware processors:
a memory storing instructions that, when executed by the one or more hardware processors, cause the one or more hardware processors to perform operations comprising:
receiving, using a location inspection computing device, a listing of one or ore locations, properties, units, parcels or sections to be inspected;
receiving, by the location inspection computing device, at least one first rating of one or more characteristics associated with the one or more locations, properties, units, parcels or sections, the first rating being based on perceived importance of the one or more characteristics as assigned by and entered by a user;
receiving, by the location inspection computing device, additional locations, properties, units, parcels or sections included in the location inspection tour and at least one second rating of the one or more characteristic being provided by the user while inspecting each location, property, unit, parcel or section; and
computing, by the location inspection computing device, a composite rating for the listing of each location, property, unit, parcel or section based on the first rating and the second rating.

11. The location inspection computing device as claimed in claim 10, wherein the composite rating is the weighted sum of the first rating and the second rating.

12. The location inspection computing device as claimed in claim 10, wherein the memory stores further instructions that when executed by the one or more hardware processors cause the one or more hardware processors to perform operations comprising:
generating, by the location inspection computing device, a list view and a map view of the listing of one or more locations, properties, units, parcels or sections, wherein ordering of the listing of the one or more locations, properties, units, parcels or sections in the list view correspond to numerals assigned to the one or more locations, properties, units, parcels or sections in the map view, and wherein numerals assigned to the one or more locations, properties, units, parcels or sections changes in response to change in the ordering of the listing of the one or more locations, properties, units, parcels or sections in the list view.

13. The location inspection computing device as claimed in claim 10, wherein the memory stores further instructions that, when executed by the one or more hardware processors, cause the one or more hardware processors to perform operations comprising:
receiving notes and photographic images of listing of one or more locations, properties, units, parcels or sections from the user while on site.

14. The location inspection computing device as claimed in claim 10, wherein the one or more characteristics associated with one or ore locations properties, units, parcels or sections comprise at least one of price, size, location, layout, aesthetics, amenities, common area, security and parking.

15. The location inspection computing device as claimed in claim 10, wherein the one or more locations, properties, units, parcels or sections comprise at least one of on sale locations, properties, units, parcels or sections or on lease locations, properties, units, parcels or sections.

16. The location inspection computing device as claimed in claim 10, wherein receiving, by the location inspection computing device, a listing of one or more locations, properties, units, parcels or sections based on one or more inputs from the user and the received rating comprises:
receiving a listing of one or more locations properties, units, parcels or sections from a locally residing database, wherein the locally residing database comprises listing of one or more locations, properties, units, parcels or sections fetched from a communicatively coupled remote database, the remote database being a read only database.

17. The location inspection computing device as claimed in claim 16, wherein receiving, by the computing device, the listing of one or more locations, properties, units, parcels or sections based on one or more inputs from the user and the received rating comprises:
receiving the listing of one or more locations, properties, units, parcels or sections manually entered by the user in the locally residing database.

18. The location inspection computing device as claimed in claim 10, wherein the memory stores further instructions that, when executed by the one or more hardware processors, cause the one or more hardware processors to perform operations comprising:
generating a ratings report related to inspection of the listing of locations, properties, units, parcels or sections.

19. A non-transitory computer readable medium storing instructions for facilitating a location inspection that, when executed by one or more hardware processors, cause the one or more hardware processors to perform operations comprising:
receiving, using a location inspection computing device, a listing of one or more locations, properties, units, parcels or sections to be inspected;
receiving, by the location inspection computing device, at least one first rating of one or more characteristics associated with the one or more locations, properties, units, parcels or sections, the first rating being based on perceived importance of the one or more characteristics as assigned by and entered by a user;
receiving, by the location inspection computing device, additional locations, properties, units, parcels or sections included in the location inspection tour and at least one second rating of the one or more characteristic being provided by the user while inspecting each location, property, unit, parcel or section; and
computing, by the location inspection computing device, a composite rating for the listing of each location, property, unit, parcel or section based on the first rating and the second rating.

20. The non-transitory computer readable medium as claimed in claim 19, wherein the composite rating is the weighted sum of the first rating and the second rating.

21. The non-transitory computer readable medium as claimed in claim 19, wherein the medium stores further instructions that when executed by the one or more instructions cause the one or more hardware processors to perform operations comprising:
generating, by the location inspection computing device, a list view and a map view of the listing of one or more locations, properties, units, parcels or sections, wherein ordering of the listing of the one or more locations, properties, units, parcels or sections in the list view correspond to numerals assigned to the one or more location properties, units, parcels or sections in the map view, and wherein numerals assigned to the one or more locations, properties, units, parcels or sections changes in response to change in the ordering of the listing of the one or more locations, properties, units, parcels or sections in the list view.
